(19) United States
(12) Patent Application Publication
(10) Pub. No.: US 2014/0245018 A1
(43) Pub. Date: Aug. 28, 2014

(54) Systems and Methods for Media Recognition

(71) Applicants: Mark Randall Mooneyham, Folsom, CA (US); James Moorer, Panacea, FL (US)

(72) Inventors: Mark Randall Mooneyham, Folsom, CA (US); James Moorer, Panacea, FL (US)

(73) Assignee: ADOBE SYSTEMS INCORPORATED, San Jose, CA (US)

(21) Appl. No.: 12/252,694

(22) Filed: Oct. 16, 2008

(51) Int. Cl. H04L 9/00

(52) U.S. Cl. 713/176

(57) ABSTRACT

Certain embodiments described herein provide methods and systems for media recognition. One exemplary embodiment involves recognizing a piece of media in two steps. First, a watermark may be recognized that identifies that the media has a media identifying fingerprint. Second, that fingerprint is retrieved and used to recognize the media content. Using a combination of watermarking and fingerprinting techniques provides various advantages, for example, it may address traditional inaccuracies involved with watermarking while reducing the computational power and bandwidth required to analyze every piece of media for a fingerprint.

### FIELD

Embodiments of the present disclosure relate generally to computer applications and systems that distribute, use, and monitor electronic media.

### BACKGROUND

Various techniques allow computers and other devices to recognize a piece of media from the media itself. One technique embeds a watermark inside a piece of media that is not noticeable by the human senses and that includes a unique identifier for the media. The watermark may be a signal or other payload embedding the identifier as bytes of data, for example as a noise pattern. Such watermarking can be error prone and inaccurate, for example, because of any encoding, decoding, compression, or other alteration of a piece of media. As specific examples, a watermark may be obscured or lost when a piece of media is compressed for Internet streaming or compressed when the piece of media is put on disk.

Another technique that allows computers to recognize a piece of media from the media itself uses fingerprinting. Such fingerprinting involves analyzing the piece of media and deriving a fingerprint or signature from certain characteristics of the media itself. As an example, the light/dark pattern of a video may be used to create a fingerprint, e.g., a small number of digits that are unique enough to that piece of media to distinguish it from the fingerprints of other pieces of media. While fingerprinting is generally very accurate, among other disadvantages, fingerprinting tends to be very processing intensive. For example, it may require downloading and analyzing an entire piece of media. In addition, given the subtle changes to a fingerprint caused by compression and other alterations to a piece of media, fingerprinting may also require a computationally intensive “fuzzy” matching process to match a fingerprint derived from a piece of media with the identify of the media. Generally, the processing requirements of fingerprinting may make it ill-suited for many media recognition applications. As examples, fingerprinting may be infeasible or impractical in cases where the number of pieces of media to be analyzed is large and/or in cases where a low percentage of the analyzed pieces of media actually have fingerprints that identify the media.

### SUMMARY

Certain embodiments described herein provide methods and systems for media recognition. One exemplary computer implemented method uses both a higher-complexity indicator, such as a fingerprint, and a lower-complexity indicator to recognize a piece of media. The lower-complexity indicator can indicate whether or not the recipient of the piece of media can use a higher-complexity and often more time/processor intensive technique to recognize the media. An exemplary method involves identifying a higher-complexity indicator from a piece of media and providing the higher-complexity indicator for inclusion in a database entry in a database. The database entry may associate the higher-complexity indicator with media recognition information for the piece of media. The method further involves embedding a lower-complexity indicator in the piece of media. The lower-complexity indicator indicates to media consumption devices receiving the piece of media that the higher-complexity indicator can be identified from the piece of media and used to find the media recognition information for the piece of media. The method may involve providing the media recognition information for the piece of media from the database to one of the media consumption devices in response to receiving a request identifying the higher-complexity indicator.

One exemplary embodiment comprises receiving a piece of media, determining whether the piece of media comprises a lower-complexity indicator, and, if so, identifying a higher-complexity indicator from the piece of media and using the higher-complexity indicator to retrieve remotely stored media recognition information for the piece of media.

Another exemplary method comprises receiving a collection of pieces of media and, for each piece of media, determining whether the piece of media comprises a lower-complexity indicator. If a piece of media comprises the lower-complexity indicator, the method involves identifying a higher-complexity indicator from the piece of media and using the higher-complexity indicator to retrieve the media recognition information. The media recognition information may comprise a media identifier, a media title, and/or a media source, among other things, and identify a particular piece of media within the collection of pieces of media.

Yet another exemplary method comprises providing fingerprints from pieces of media for storage in a database with media recognition information for the pieces of media and embedding a watermark in the pieces of media. The watermark indicates by its presence or content that fingerprint database look-up is available for the pieces of media. The method further comprises searching a collection of media by scanning the collection for the presence of the watermark and, in cases where the watermark is present, performing a fingerprint database look-up to retrieve media recognition information from the database. The media recognition information may be used to identify a first piece of media within the collection of media.

In other embodiments, a computer-readable medium (such as, for example, random access memory or a computer disk) comprises code for carrying out these methods.

These embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an illustrative network environment according to certain embodiments;

FIG. 2 is a flow chart illustrating a method of recognizing media according to certain embodiments; and

FIG. 3 is a flow chart illustrating a method of recognizing a received piece of media according to certain embodiments.

### DETAILED DESCRIPTION

The following specific illustrative embodiment is provided to illustrate some of the applications, uses, and benefits of exemplary methods and systems for media recognition. One exemplary embodiment involves recognizing a media content (e.g., files, streaming media, etc.) in two steps. First, a watermark may be recognized that simply identifies that the media has a media identifying fingerprint. Second, that fingerprint is retrieved and used to recognize the media content. Using a combination of watermarking and fingerprinting techniques provides various advantages, for example, it may address traditional inaccuracies involved with watermarking while reducing the computational power and bandwidth required to analyze every piece of media for a fingerprint.

Certain of the methods and systems described also make it feasible to recognize media in circumstances in which it may have previously been unfeasible. For example, media viewing computer applications may be enabled to recognize media in cases where the number of pieces of media to be analyzed is large and/or in cases where a low percentage of the analyzed pieces of media actually have fingerprints that identify the media. Certain of the techniques disclosed are particularly well-suited for use in the context of huge amounts of media and/or the use of media provided on the Internet.

Certain embodiments of the present invention check for a watermark as an initial step in recognizing a piece of media. Any suitable type of traditional or nontraditional watermark can be used. Certain embodiments utilize watermarks that are smaller than many traditional watermarks, including the use of a watermark comprising only a single byte or even a single bit. There may be advantages to using simple or small watermarks in certain embodiments, however, the use of such watermarks is not employed in all embodiments. A simple watermark may be recognized on a variety of devices and on devices that use simple media players, including cell phones and other mobile devices. Such simple watermarks may not store enough data to record a unique identifier for a piece of media, but may nonetheless have enough storage for the watermark to indicate that the associated piece of media has been fingerprinted and is thus in a fingerprint look-up database. A watermark can be repeated throughout a piece of media. In certain embodiments, a watermark or portion of a watermark will be visible or otherwise observable in a piece of media.

A watermark can be as simple as a yes/no indicator, e.g., if the watermark is found one knows that there is a fingerprint that is associated with the piece of media. Alternatively, a watermark may indicate a fingerprint source or database that should be utilized. A watermark may include alternative or additional information as well. In many cases, a watermark check can be performed very quickly. For example, a watermark check may be performed in only a few seconds or less in some cases. It may only be necessary to analyze the first couple of seconds of the video to identify a watermark.

To improve the reliability of watermarking, a watermark may be inserted at multiple locations within a piece of media. A small watermark may be represented in a smaller picture area with less resolution and/or over a shorter duration within a length of a piece of media. In addition, the smaller the watermark, the more time it can be duplicated within a piece of media. According, smaller watermarks may be used in certain embodiments to improve the reliability of the watermark, for example, by reducing the chances that a watermark will be lost as a result of any encoding, decoding, compression, or other alteration. Small watermarks may also be easier/quicker to identify. For example, a complete watermark may be found by scanning the first 10 seconds of a piece of media in which the watermark is repeated three or more times. Thus, statistically, by providing multiple copies of a relatively small watermark, certain embodiments improve the chances and efficiency of recognizing a watermark. The watermark may be placed in the video, sound, or any other portion oo combination of portions of a piece of media.

Generally, a media consuming device can perform a preliminary watermark check to determine whether it is necessary to do a fingerprint analysis and look-up at all. The processing intensive fingerprint analysis and lookup can thus be avoided in cases where fingerprint recognition is not applicable. Certain embodiments facilitate media recognition in cases where the quantity of media is large. For example, a search application may search for particular pieces of media that are published somewhere on the Internet. The application could quickly go through huge quantities of Internet published media looking for a watermark indicating that the media has a fingerprint. Since much of the material will not have the watermark, the potentially time consuming fingerprint analysis can be performed on a significantly reduced population of materials.

Generally, once an application has identified a piece of media, it can initiate a variety of useful functions, for example, it may send a message to an analytics or monitoring system identifying that the particular piece of media or portion of media is being viewed. Analytics and monitoring may relate to tracking number of views, number of views of particular content, number of views of content belonging to certain individuals or entities, reporting on rights managements. Other exemplary uses relate to access control. For example, the media identifying information may be used to block, restrict, or otherwise control the access to the piece of media, for example, based on some factor such as whether the application is authenticated/permitted to playback the content or whether the application has already played the content once (e.g., for free trial content). Still other exemplary uses relate to advertising. For example, an advertisement or a particular advertisement may be queued or otherwise provided based on the identified piece of media.

These illustrative examples are given to introduce the reader to the general subject matter discussed herein and are not intended to limit the scope of the disclosed concepts. The following sections describe various additional embodiments and examples of methods and systems for using media and associated metadata.

### Illustrative Network Configuration

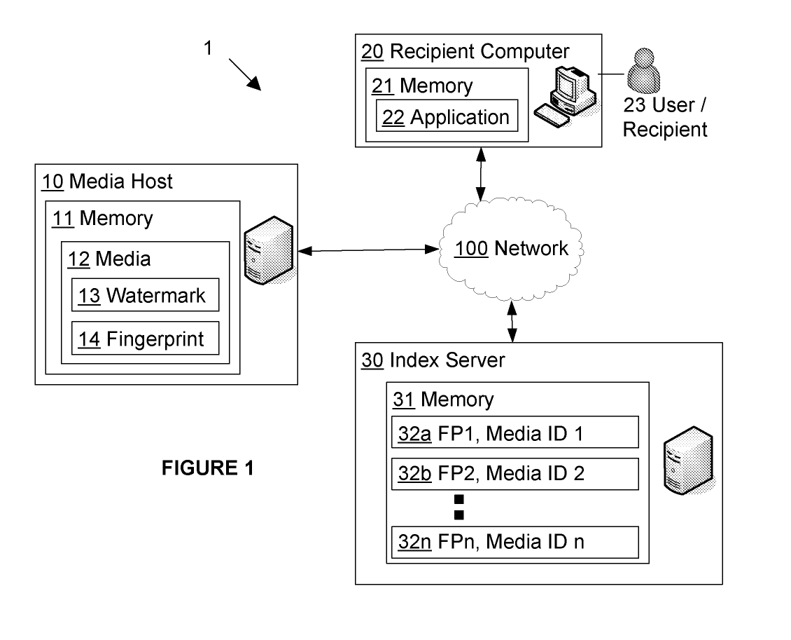

Referring now to the drawings in which like numerals indicate like elements throughout the several Figures, FIG. 1 is a system diagram illustrating an illustrative network environment according to certain embodiments. Other embodiments may be utilized. The environment 1 shown in FIG. 1 comprises a wired or wireless network 100 connecting various network devices 10, 20, 30. Applications that execute on each of the devices 10, 20, 30 are shown as functional or storage components residing in memory 11, 21, 31 on the respective devices. As is known to one of skill in the art, such applications may be resident in any suitable computer-readable medium and execute on any suitable processor. For example, the network devices 10, 20, 30 shown each may comprise a computer-readable medium such as a random access memory (RAM) 11, 21, 31 coupled to a processor that executes computer-executable program instructions stored in memory 11, 21, 31. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The network 100 shown comprises the Internet. In other embodiments, other networks, such as an intranet, or no network may be used. Moreover, methods may operate within a single device. The devices 10, 20, 30 can be connected to a network 100 as shown. Alternative configurations are of course possible. The devices 10, 20, 30 may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media consuming programs. The server devices 10, 30 depicted as single computer systems, may be implemented as a network of computers or processors. Examples of a server device are servers, mainframe computers, networked computers, a processor-based device, and similar types of systems and devices.

For FIG. 1, a system figure that illustrates a media host 10 providing a piece of media 12 to a recipient computer 20 is shown. An application 22 on the recipient computer 20 recognizes a watermark 13 in the piece of media 12. The watermark 13 indicates to the application 22 that there is a media identifying entry 32a in a remote index server 30 that can be used to recognize the piece of media. The application 22 performs a fingerprint analysis on the piece of media 12 and uses the recovered fingerprint 14 in a request sent to the index server 30. The index server comprises a table or database that pairs fingerprints (FP1, FP2, . . . FPn) with information about the piece of media, such as a media identifier, the media's title, the media's source, etc. Given the subtle changes to a fingerprint caused by compression and other alterations to a piece of media, an index server 30 lookup may involve a “fuzzy” matching process that matches a fingerprint 14 derived from a piece of media 12 with the fingerprints (FP1, FP2, . . . FPn) stored at the server 30.

The recipient computer 20 may be any type of media consuming device. Such a device may be used to play back, deliver, and/or serve media content. Examples include a device with Adobe® Flash® software, a device using the Adobe® AIR® platform, a device using an Adobe® Acrobat® product, a set top box, or other media consuming fixed or portable devices. A consumption device could be a server that is serving out the media. In one embodiment, such a server device recognizes pieces of media prior to making them available to others.

### Exemplary Methods of Recognizing Media

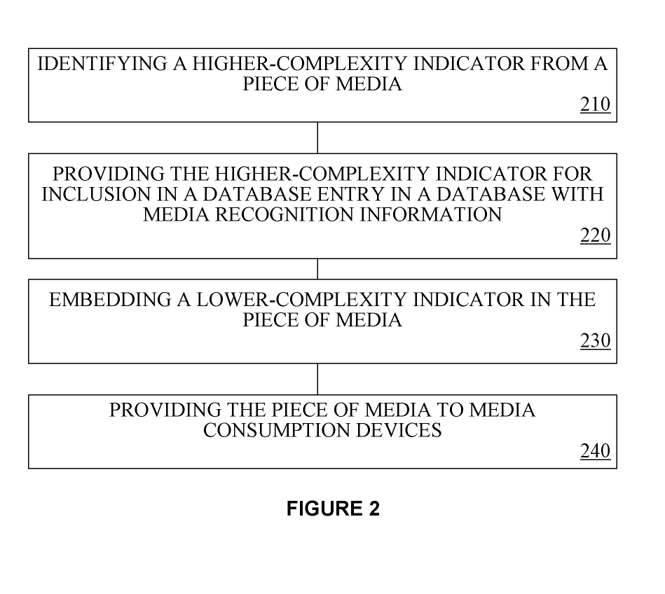

FIG. 2 is a flow chart illustrating a method of recognizing media according to certain embodiments. For purposes of illustration only, the elements of this method are described with respect to a particular implementation. A variety of other implementations are also possible.

In the method shown in FIG. 2, a higher-complexity indicator, such as a fingerprint, is identified from a piece of media, as shown in block 210. This identification can be done at any suitable time including during the development of the piece of media and while the piece of media is being hosted or provided by a media providing host. For example, media host 10 shown in FIG. 1 may identify a higher-complexity indicator for some or all of the pieces of media that it hosts.

In the method shown in FIG. 2, the higher-complexity indicator is provided for inclusion in a database entry in a database, as shown in block 220. The database entry may associate the higher-complexity indicator with media recognition information for the piece of media. For example, the entry may include a number or number range representing a fingerprint and one or more fields representing media recognition information such as a media identifier, a media title, a media source, among other things. FIG. 1 illustrates exemplary database entries 32a-32n that associate fingerprint higher-complexity indicators with media identifiers. Any entity or person may provide the higher-complexity indicator for storage and retrieval. For example, media host 10 shown in FIG. 1 may identify a higher-complexity indicator for some or all of the pieces of media that it hosts and provide these higher-complexity indicators along with media identifiers to an index server 30 where the indicators and identifiers are associated and made available for retrieval.

The method shown in FIG. 2 further comprises embedding a lower-complexity indicator in the piece of media, as shown in block 230. The low complexity indicator indicates to media consumption devices receiving the piece of media that the higher-complexity indicator can be identified from the piece of media and used to find the media recognition information for the piece of media. A watermark is an example of a lower-complexity indicator. However, a lower-complexity indicator can be any indicator that is of lower-complexity than the higher-complexity indicator.

A lower-complexity indicator may comprise as little as a single byte of information and may provide the necessary indication simply by being present or not present. In other words, if the lower-complexity indicator is present, receiving media devices recognize that a higher-complexity indicator is also present and can be used to recognize the piece of media. A lower-complexity indicator may identify a database or provide other useful information. A lower-complexity indicator may be repeated in multiple instances within a piece of media, for example, as multiple instances of a watermark embedded in the piece of media. A lower-complexity indicator such as a watermark may be embedded or otherwise included in one or more portions of a piece of media including, but not limited to, within the sound portion or the video portion of a piece of video media. The low complexity indicator may be perceivable by a human or unperceivable by a human.

The method shown in FIG. 2 may further comprise providing the piece of media to media consumption devices, as shown in block 230. When such devices receive the piece of media, they may examine the piece of media to determine whether the lower-complexity indicator indicates that a higher-complexity indicator is present and usable. If so, such devices may request retrieve the higher-complexity indicator and use it to request media recognition information from the database. The media recognition information for the piece of media may then be provided from the database to one or more of the media consumption devices in response to receiving any requests identifying the higher-complexity indicator.

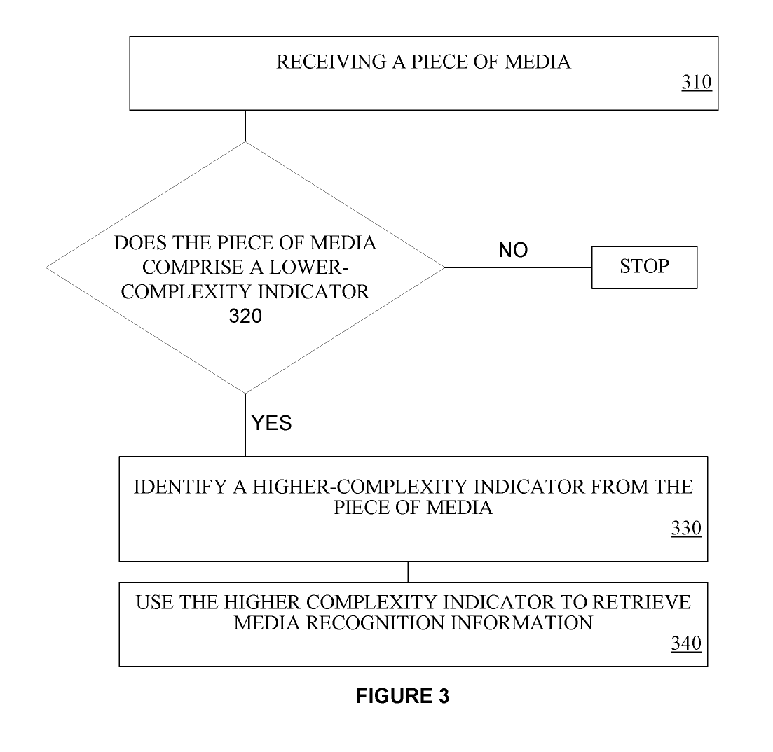

FIG. 3 is a flow chart illustrating a method of recognizing a received piece of media according to certain embodiments. For purposes of illustration only, the elements of this method are described with respect to a particular implementation. A variety of other implementations are also possible.

The method shown in FIG. 3 comprises receiving a piece of media, as shown in block 310. The piece of media may be received over an network such as the Internet, as part of a collection of pieces of media to be searched, or in a variety of other circumstances. The piece of media may be received at a media consuming device that will play the piece of media for a consumer or provide the piece of media to a consumer through a network or otherwise.

The method shown in FIG. 3 further comprises determining whether a received piece of media comprises a lower-complexity indicator, as shown in block 320. The lower-complexity indicator indicates that a higher-complexity indicator can be identified from the piece of media and used to find media recognition information for the piece of media. If the piece of media does not comprise the lower-complexity indicator, the method stops. In the case of a collection of pieces of media received, each piece of media may be examined for the lower-complexity indicator.

If the piece of media comprises the lower-complexity indicator, the method shown in FIG. 3 involves identifying a higher-complexity indicator from the piece of media, as shown in block 330. In the case of a collection of pieces of media, for each piece of media that comprises the lower-complexity indicator, a higher-complexity indicator can be identified.

The method shown in FIG. 3 further comprises using the higher-complexity indicator to retrieve the media recognition information, as shown in block 340. In the case of a collection of pieces of media, the ability to recognize pieces of media within the collection allows one or more particular pieces of media to be identified. For example, a collection of media can be searched to determine whether a particular movie is amongst the collection. If the movie is marked with the lower-complexity indicator, the method determines that pieces of media lacking the lower-complexity indicator are not a match for the movie. The pieces of media that are marked with the lower-complexity indicator can be further analyzed using a higher-complexity indicator within each to recognize each piece of media and determine whether any of those pieces of media are a match for the searched for movie.

### General

Certain embodiments relate to recognizing a piece of media using a two step recognition process. These are merely illustrative. The techniques for recognizing media and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

1. A computer implemented method comprising:
identifying a fingerprint from media content to be provided via streaming;
providing the fingerprint for inclusion in a database entry in a database, the database entry associating the fingerprint with media recognition information for the media content; and
embedding a multi-byte watermark in at least one of audio content or video content of the media content, the watermark indicating to media consumption devices receiving the media content that the fingerprint can be identified from the media content and used to find the media recognition information for the media content.

2-4. (canceled)

5. The method of claim 1, wherein multiple instances of the watermark are embedded in the media content.

6-7. (canceled)

8. The method of claim 2, wherein the watermark is embedded in a sound portion of the media content.

9. The method of claim 2, wherein the watermark is embedded in a video portion of the media content.

10. The method of claim 1, wherein the watermark is a visible or audible indicator.

11. (canceled)

12. The method of claim 1 further comprising providing the media content to the media consumption devices.

13. The method of claim 11, further comprising providing the media recognition information for the media content from the database to one of the media consumption devices in response to receiving a request identifying the fingerprint.

14. A computer implemented method comprising:
receiving streaming media content;
determining that the media content comprises a multi-byte watermark embedded in at least one of audio content or video content of the streaming media content, the watermark indicating that a fingerprint can be identified from the streaming media content; and
responsive to determining that the audio content or video content includes the watermark:
identifying the fingerprint from the media content, and
retrieving media recognition information from a database using the fingerprint.

15-16. (canceled)

17. The method of claim 14 further comprising using the media recognition information to track a number of views of the media content.

18. The method of claim 14 further comprising using the media recognition information to track a number of views of any media content belonging to a given entity.

19. The method of claim 14 further comprising using the media recognition information to control access to the media content based on the application used to consume the content.

20. The method of claim 14 further comprising providing an advertisement using the media recognition information.

21. A computer implemented method comprising:
receiving a collection of pieces of streaming media;
for each piece of media:
determining the piece of streaming media comprises a multi-byte watermark embedded in at least one of audio content or video content of the piece of streaming media, the watermark indicating that a fingerprint can be identified from the piece of streaming media; and
responsive to determining that the audio content or video content includes the watermark:
identifying the fingerprint from the piece of media,
retrieving media recognition information from a database using the fingerprint.

22. The method of claim 21 further comprising using the media recognition information retrieved to identify a piece of media within the collection of pieces of streaming media.

23. The method of claim 21, wherein the media recognition information comprises one or more of a media identifier, a media title, or a media source.

24. A computer implemented method comprising:
providing fingerprints from media content to be provided via streaming for storage in a database with media recognition information for the media content;
embedding a multi-byte watermark comprising data within the media content in at least one of audio content or video content of the media content, the watermark indicating that fingerprint database look-up is available for the media content; and
searching a collection of media by:
scanning the collection for the presence of the watermark; and
responsive to detecting the watermark is present via the scan, performing a fingerprint database look-up to retrieve the media recognition information from the database.

25. The method of claim 19 further comprising using the media recognition information to identify a first piece of media within the collection of media.

26-30. (canceled)

31. The method of claim 14, wherein the watermark identifies the database including the media recognition information for the media content and further comprising accessing the database responsive to determining that the audio content or video content includes the watermark.

32. A system comprising:
a non-transitory computer-readable medium configured to store instructions;
a processor configured to execute the instructions stored in the non-transitory computer-readable medium to perform operations comprising:
identifying a fingerprint from media content to be provided via streaming;
providing the fingerprint for inclusion in a database entry in a database, the database entry associating the fingerprint with media recognition information for the media content; and
embedding a multi-byte watermark in at least one of audio content or video content of the media content, the watermark indicating to media consumption devices receiving the media content that the fingerprint can be identified from the media content and used to find the media recognition information for the media content.

33. A system comprising:
a non-transitory computer-readable medium configured to store instructions;
a processor configured to execute the instructions stored in the non-transitory computer-readable medium to perform operations comprising:
receiving streaming media content;
determining that the media content comprises a multi-byte watermark embedded in at least one of audio content or video content of the streaming media content, the watermark indicating that a fingerprint can be identified from the streaming media content; and
responsive to determining that the audio content or video content includes the watermark:
identifying the fingerprint from the media content, and
retrieving media recognition information using the fingerprint.

34. A non-transitory computer-readable medium on which is encoded program code, the program code comprising:
program code for identifying a fingerprint from media content to be provided via streaming;
program code for providing the fingerprint for inclusion in a database entry in a database, the database entry associating the fingerprint with media recognition information for the media content; and
program code for embedding a multi-byte watermark in at least one of audio content or video content of the media content, the watermark indicating to media consumption devices receiving the media content that the fingerprint can be identified from the media content and used to find the media recognition information for the media content.

35. A non-transitory computer-readable medium on which is encoded program code, the program code comprising:
program code for receiving streaming media content;
program code for determining that the media content comprises a multi-byte watermark embedded in at least one of audio content or video content of the streaming media content, the watermark indicating that a fingerprint can be identified from the streaming media content; and
program code for responsive to determining that the audio content or video content includes the watermark:
identifying the fingerprint from the media content, and
retrieving media recognition information using the fingerprint.
